(19) United States
(12) Patent Application Publication
(10) Pub. No.: US 2023/0134979 A1
(43) Pub. Date: May 4, 2023

(54) ELECTRICAL BOX EXTENDER BACKER PLATE

(71) Applicant: Phillip J. Gross, Leesville, SC (US)

(72) Inventor: Phillip J. Gross, Leesville, SC (US)

(21) Appl. No.: 17/975,786

(22) Filed: Oct. 28, 2022

Related U.S. Application Data
(60) Provisional application No. 63/273,332, filed on Oct. 29, 2021.

(51) Int. Cl. H02G 3/08

(52) U.S. Cl. CPC H02G 3/085

(57) ABSTRACT

A backer plate for use with an electrical box extender to form an electrical box is provided. The backer plate includes a planar wall defining a perimeter, four edges along the perimeter, and four corners between adjacent edges, the planar wall further defining at least a first threaded opening located at a first corner of the four corners and a second threaded opening located at a second corner of the four corners, wherein the first and second threaded opening are configured to rotatably engage with a first and second threaded fastener, respectively, to fasten the electrical box extender to the planar wall of the backer plate to form the electrical box

### CROSS-REFERENCE TO RELATED APPLICATIONS

This application is a non-provisional application claiming the benefit of priority under 35 U.S.C. § 119(e) to U.S. Provisional Application No. 63/273,332, filed Oct. 29, 2021, which is hereby incorporated by reference in its entirety.

### FIELD

The present disclosure relates to a backer plate for use with an electrical box extender to enable the electrical box extender to function as a complete electrical box.

### BACKGROUND

Industrial electrical boxes are widely used in industrial construction and may be mounted to, e.g., walls, ceilings, and/or floors. Typical industrial electrical boxes include a backplate, four walls extending perpendicularly from such backplate, and an open face. Conduits housing one or more electrical wires may be mounted to one or more of the four walls. The one or more electrical wires may extend through the industrial electrical box to another conduit, or alternatively may be attached to an electrical device mounted over the open face. For example, in certain applications, one or more electrical power lines extend through a conduit attached to one of the four walls of the electrical box and attach to an electrical outlet mounted over the open face of the electrical box.

Certain building codes generally provide that no more than a predetermined amount of electrical wires may be present in an electrical box of a certain size. Accordingly, if making modifications to an electrical system of a building includes adding more than the predetermined amount of electrical wires to the electrical box, the electrical box must be extended in size to accommodate such additional electrical wires. Electrical box extenders may then attach to the electrical box, thus increasing the size available to house the electrical wires.

### SUMMARY

Discussed herein are various devices and systems related to creating an electrical box.

In one exemplary aspect, a backer plate is provided for use with an electrical box extender to form an electrical box, the backer plate including: a planar wall defining a perimeter, four edges along the perimeter, and four corners between adjacent edges, the planar wall further defining at least a first threaded opening located at a first corner of the four corners and a second threaded opening located at a second corner of the four corners, wherein the first and second threaded opening are configured to rotatably engage with a first and second threaded fastener, respectively, to fasten the electrical box extender to the planar wall of the backer plate to form the electrical box.

For example, the backer plate may be provided, wherein the four edges include a first edge, a second edge, a third edge, and a fourth edge, and wherein each of the first edge, the second edge, the third edge and the fourth edge are all equal in length.

For example, the backer plate may be provided, wherein the four edges of the backer plate forms a square shape that measures four inches by four inches, or 4 11/16 inches by 4 11/16 inches.

For example, the backer plate may be provided, wherein the first threaded opening and the second threaded opening each include an 8/32nd of an inch in diameter threading.

For example, the backer plate may be provided, wherein the planar wall defines a plurality of knockouts configured to receive one or more of an electrical conduit.

For example, the backer plate may be provided, wherein the planar wall defines a plurality of internal openings placed in between the plurality of knockouts, wherein each of a given internal opening from the plurality of internal openings includes a smaller area than each of a given knockout area from the plurality of knockouts.

In another exemplary aspect of the present disclosure, an electrical box assembly is provided. The electrical box assembly includes: a backer plate having a planar wall defining a perimeter, four edges along the perimeter, and four corners between adjacent edges, the planar wall further defining at least a first threaded opening located at a first corner of the four corners and a second threaded opening located at a second corner of the four corners; an electrical box extender separate from the backer plate, the electrical box extender including four wall and defining a first electrical box extender opening and a second electrical box extender opening; and a first threaded fastener extending through the first electrical box extender opening and engaged with the first threaded opening and a second threaded fastener extending through the second electrical box extender opening and engaged with the second threaded opening, the first and second threaded fasteners coupling the electrical box extender to the backer plate to form an electrical box.

For example, the electrical box assembly may be provided, wherein the four walls of the electrical box extender extend perpendicularly from the backer plate.

For example, the electrical box assembly may be provided, wherein the four walls of the electrical box extender extend perpendicularly from the four edges of the backer plate.

For example, the electrical box assembly may be provided, wherein the electrical box extender includes a first half and a second half, wherein both the first half and the second half each include a male end and a female end, wherein each of the female end and the male end together form one of the first electrical box extender opening or the second electrical box extender opening.

For example, the electrical box assembly may be provided, wherein the planar wall defines a plurality of knockouts configured to receive one or more of an electrical conduit.

For example, the electrical box assembly may be provided, wherein the planar wall defines a plurality of internal openings placed in between the plurality of knockouts, wherein each of a given internal opening from the plurality of internal openings includes a smaller area than each of a given knockout area from the plurality of knockouts.

For example, the electrical box assembly may be provided, wherein the four edges include a first edge, a second edge, a third edge, and a fourth edge, and wherein each of the first edge, the second edge, the third edge and the fourth edge are all equal in length.

For example, the electrical box assembly may be provided, wherein the four edges of the backer plate forms a square shape that measures four inches by four inches.

For example, the electrical box assembly may be provided, wherein the first threaded opening and the second threaded opening each include an 8/32nd of an inch in diameter threading.

In an exemplary aspect of the present disclosure, a method of forming an electrical box assembly is provided. The method includes: providing a backer plate including a planar wall defining a perimeter, four edges along the perimeter, and four corners between adjacent edges, the planar wall further defining at least a first threaded opening located at a first corner of the four corners and a second threaded opening located at a second corner of the four corners; providing an electrical box extender separate from the backer plate, the electrical box extender including four wall and defining a first electrical box extender opening and a second electrical box extender opening; and coupling the electrical box extender to the backer plate with a first threaded fastener extending through the first electrical box extender opening and engaged with the first threaded and with a second threaded fastener extending through the second electrical box extender opening and engaged with the second threaded opening.

For example, the method may be provided, wherein the four walls of the electrical box extender extend perpendicularly from the backer plate.

For example, the method may be provided, wherein the four walls of the electrical box extender extend perpendicularly from the four edges of the backer plate.

For example, the method may be provided, wherein the electrical box extender includes a first half and a second half, wherein both the first half and the second half each include a male end and a female end, wherein each of the female end and the male end together form one of the first electrical box extender opening or the second electrical box extender opening.

For example, the method may be provided, wherein the planar wall defines a plurality of knockouts configured to receive one or more of an electrical conduit.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of an electrical box in accordance with an exemplary aspect of the present disclosure.

FIG. 2 is a top, planar view of the exemplary backer plate used to form the electrical box of FIG. 1.

FIG. 3 is a perspective view of the exemplary backer plate.

FIG. 4 is a perspective, exploded view of a electrical box extender.

FIG. 5 is a perspective view of an assembled version of the electrical box extender of FIG. 4 and fastened to the backer plate of FIGS. 2 and 3.

FIG. 6 shows another perspective view of the assembly of FIG. 5.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In general, the present disclosure is related to a backer plate that may be used with an electrical box extender to enable the electrical box extender to function as a complete, five-walled (all four side walls and back wall) electrical box. The exemplary backer plate of the present disclosure may be used with most electrical box extenders, such as the modular electrical box extender described in U.S. Pat. No. 9,806,507, issued Oct. 31, 2017, the entire contents of which are incorporated herein by reference. The exemplary backer plate includes threaded openings to allow for screws, bolts, studs or the like to pass through openings in the electrical box extender and engage with the threaded openings of the backer plate to fasten the electrical box extender to the exemplary backer plate and form the electrical box.

Throughout the written specification when referring to a threaded fastener, a threaded fastener is defined to be any fastener that has threads, such as screws, bolts, studs, rods, etc.

Further, as used herein, the term “electrical box extender” refers to any structure capable of attachment to an underlying electrical box to extend the internal volume of the assembly, or as in the case of the present disclosure, capable of attachment to a backer plate of the present disclosure to form an electrical box.

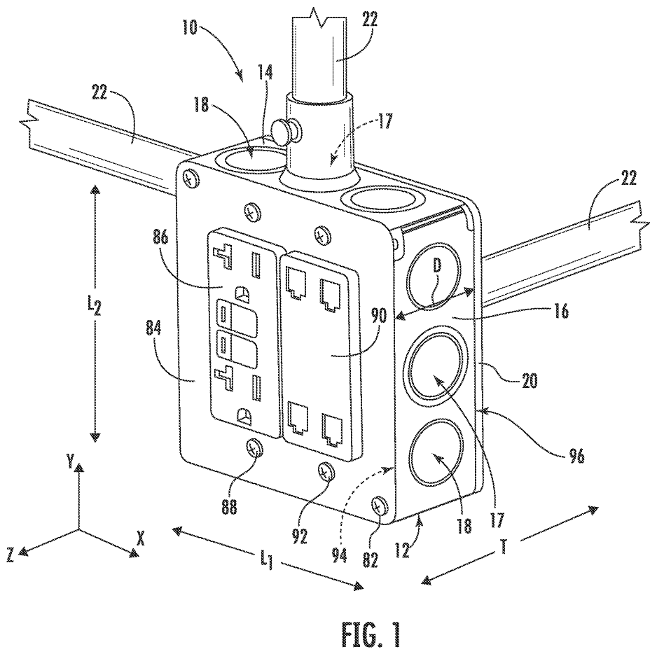

Referring now to the Figures, FIG. 1 is a perspective view of an electrical box in accordance with an exemplary aspect of the present disclosure. The electrical box generally is formed using, and includes, a backer plate, an electrical box extender, and for the embodiment depicted, a cover plate.

Referring now to the Figures, FIG. 1 is a perspective view of an electrical box 10 in accordance with an exemplary aspect of the present disclosure. The electrical box 10 generally is formed using, and includes, a backer plate 20, an electrical box extender 12, and for the embodiment depicted, a cover plate 84.

The electrical box 10 of FIG. 1 defines a coordinate system with x, y, and z-directions, each orthogonal to one another. The exemplary electrical box extender 12 depicted generally includes four walls, and more specifically four linear walls that extend perpendicularly from the backer plate 20.

In particular, for the embodiment depicted, the electrical box extender 12 is configured as a modular electrical box extender made of a first half 14 (having two walls; only one depicted in FIG. 1) and a second half 16 (also having two walls; only one depicted in FIG. 1). Operation and assembly of the exemplary electrical box extender 12 will be described in more detail below. The first half 14 and the second half 16 may attach together via a means for fastening which could include a screw or bolt (with or without a nut), a nail, anchor, rivet, threaded rod (such as studs), glue, tape, Velcro, a magnet, a pin, a thread, etc., as understood by those of ordinary skill in the art. Depicted in the exemplary electrical box of FIG. 1 is a threaded fastener 80.

The electrical box 10, when assembled to include the electrical box extender 12 and backer plate 20, has a thickness T in the z-direction, a height L2 in the y-direction, and a width L1 in the x-direction. These lengths may be standard sizes as used in the art, or customized sizes to fit unique configurations such as square, hexagonal, octagonal, or rectangular electrical boxes In at least one embodiment, the dimensions L1, L2, and D may for example be 4 inches×4 inches×1½ inches.

Alternatively, in other embodiments, the dimensions L1, L2, and D may for example be 4½ inches×8⅝ inches×1⅝ inches, 4 11/16 inches by 4 11/16 inches by ½ inches, or any other suitable size.

The electrical box 12 may generally house a power outlet device 86, a network connection device 90, or the like. The cover plate 84 generally defines one or more openings to expose these devices, and may be fastened to one or more of these devices through fasteners 88, 92.

Further, the electrical box extender 12 depicted generally includes knockouts 17, 18, which may be removed to receive a conduit 22. The knockouts 17, 18 may be circular in shape, and include various size diameter knockouts 17, 18 to accommodate various size conduits 22.

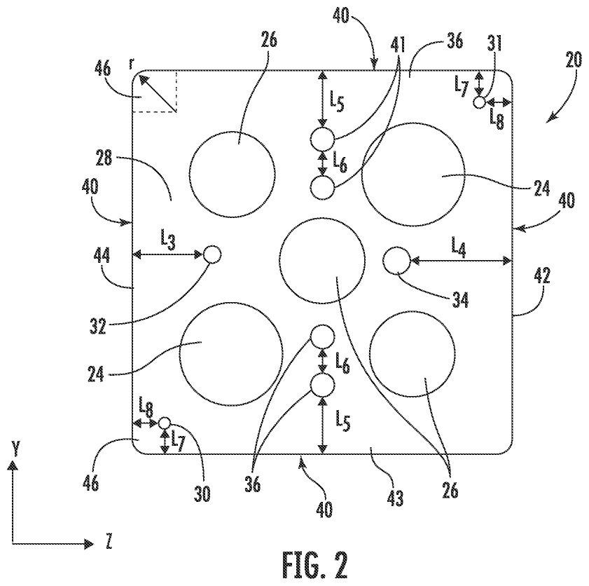

The exemplary backer plate 20 is attached to a back of the assembled first half 14 and second half 16 electrical box extender 12, or more specifically to an inner edge 96 of the electrical box extender 12, so as to form the complete electrical box 10. Although not expressly depicted, the exemplary backer plate 20 may receive electrical conduits 22 in the z-direction through knockouts 26 or 24 (not shown in FIG. 1; see FIG. 2).

Referring now to FIG. 2, the exemplary backer plate 20 includes a planar wall (not separately labeled), being generally flat. The exemplary backer plate 20 includes a plurality of knockouts 26 and 24, wherein the knockouts 26 and 24 show different size knockouts to receive different size electrical conduits 22. Examples of the diameters of the knockouts 26 and 24 may be ⅜ inches, ½ inch, ⅝ inches, ¾ inches, ⅞ inches, 1⅛ inch, 1⅜ inches, 1 inch.

These knockouts 26, 24 may form an “X” pattern, or other pattern configured to maximize the number of conduits 22 (not shown in FIG. 2) that can fit within a perimeter 40 of the backer plate 20.

The back plate 12 further defines a plurality of internal openings 34, 36, 32. The internal openings 34, 36, 32 may be used for mounting the backer plate 20 to a surface, connecting the backer plate 20 to another device ordinarily used in combination with electrical boxes 10, to mount internal electrical components of an electrical box such as the power outlet device 86 or the network connection device 90 (not shown in FIG. 2) internally, or to provide an open space for tools to be inserted into, thus enabling access for an end of a tool into an electrical box 10 through the backer plate 20. The internal openings 34, 36, or 32 may additionally or alternatively be used for wiring such as to provide an opening for a ground wire to exit through the backer plate 20.

In the exemplary embodiment depicted in FIG. 2, the planar wall of the backer plate 20 may further define four edges along the perimeter and four corners between adjacent edges. The four edges in the exemplary embodiment of FIG. 2 includes a top edge 41 with respect to the x-y plane, a right edge 42, a bottom edge 43, and a left edge 44. The lengths and overall shape determined by the combination of the four edges 41, 42, 43, 44, may form the perimeter 40 of the backer plate 20. The top and bottom edges 41, 43 may correspond to the length L1 shown in FIG. 1, and the left and right edges 42, 44 may correspond to the height L2 shown in FIG. 1.

Alternative configurations are contemplated such as six edges, eight edges, curved edges, one continuous circular curving edge, etc.

On the backer plate 20, the internal openings 34, 36, and 32 may be configured along the centerlines of the backer plate 20, such that a relatively equal distance is placed between adjacent knockouts. For example, placing internal opening 32 a relatively equal distance from both a positive y-direction from knockout 24 and a negative y-direction from knockout 26, or relatively equal upper and lower distances from knockouts 24 and 26 respectively. Internal opening 32 may be placed a distance L3 away from a left edge 44 (in the x-direction) of the perimeter 40 of backer plate 20, whereas internal opening 34 may be placed a different distance L4 from the right edge 42 (in the x-direction) of the backer plate 20, and internal opening 34 may have a different diameter compared to internal opening 32.

Internal openings 36 on the other hand may all have the same diameter, and may have equal distances L5 from a bottom edge 43 (in the y-direction) of the perimeter 40 as the distance L5 from the top edge 41 (in the y-direction) of the perimeter 40 with respect to the bottom-most and top-most internal openings 36 respectively. The internal openings 36 may each be a distance L6 from one another on the upper and lower portions of the backer plate (in the y-direction, not z-direction into page). Alternative configurations are contemplated. For example, internal openings 36 need not all be the same diameter, nor do any of the internal openings need to be placed along centerlines of the backer plate 20. The internal openings could be randomly placed in areas between the knockouts 24, 26.

As such, each of the internal openings 32, 34, or 36 may be placed on the backer plate 20 in various amounts or patterns, configured to optimize the distances between internal openings, cutouts, or edges on the backer plate 20.

Furthermore, the exemplary backer plate 20 includes two threaded openings, a first opening 30 located at a first corner (the lower left corner of the backer plate 20 in the embodiment depicted) and a second opening 31 located at a second corner (the upper right corner in the embodiment depicted; the second corner being an opposite side corner from the first corner). These threaded openings 30, 31 may be configured to be a distance L7 from a y-direction perimeter 40 edge, and a distance L8 from an x-direction perimeter 40 edge so as to match up or configure with an electrical box extender 12 (not shown) that may be used regularly in the industry. The distance L7 and distance L8 may each be less than 1 inch, such as less than 0.5 inches.

Moreover, the corners of the backer plate may be rounded corners 46 and have radius “r” so as to accommodate industry-used electrical box extenders 12 without creating inconvenient or cumbersome corners that extend further than the corners of an electrical box extender 12 used in the industry. The radius r may be less than 1.5 inches and at least 0.1 inches.

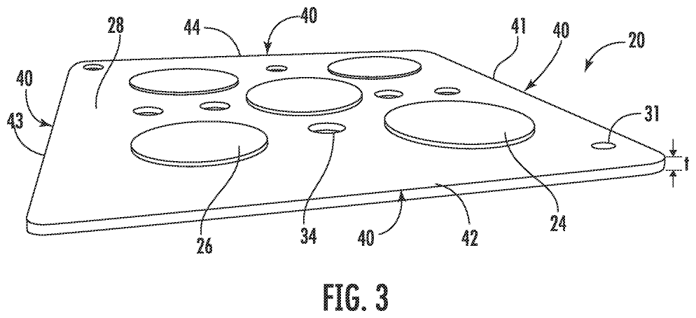

FIG. 3 provides a perspective view of the backer plate 20 of FIG. 2. As may be seen in FIG. 2, the backer plate 20 further defines a thickness “t”. The backer plate 20 is configured to be thick enough to refrain from bending under expected amounts of force (such as mounting, being fastened to an object, being tossed among a pile of other backer plates 20, near-protruding wires from the inside of a makeshift electrical box 10, etc.), while also minimizing the amount of space that the backer plate takes up on the backside of an electrical box extender 12. These knockouts 24 and 26 can easily be punched out to define a knockout opening given an amount of force less than that required were there not indented portions, so as to easily receive an electrical conduit 22 (see in FIG. 1) to give access for the electrical box 10 into the contents of the electrical conduit 22.

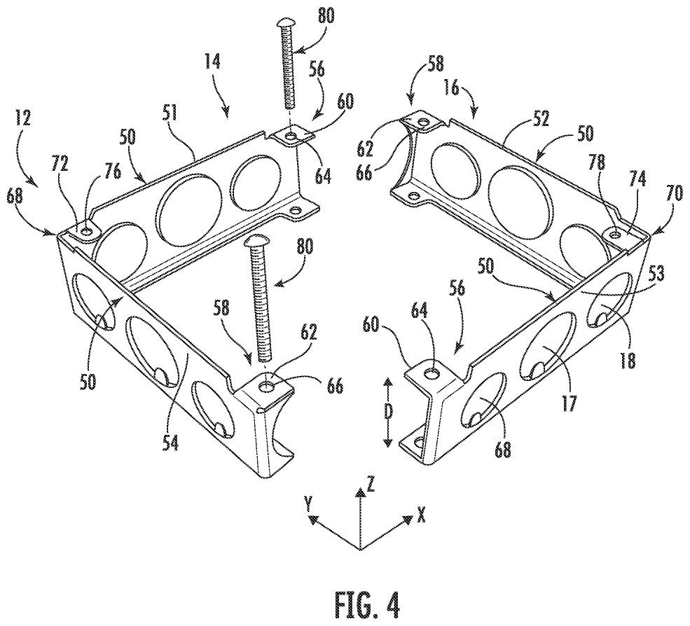

Referring now to FIG. 4, the exemplary electrical box extender 12 of the electrical box 10 of FIGS. 1 through 3 is shown as modular pieces, including the first half 14 and the second half 16. This exemplary electrical box extender may be configured in a similar manner as the exemplary electrical box extender described in U.S. Pat. No. 9,806,507, issued Oct. 31, 2017, from which the entire contents of which are incorporated herein by reference. The first half 14 and the second half 16 are modular components that when twisted 180 degrees in the x-y plane so as to replace the other's position, the first half 14 and the second half 16 are interchangeable with one another. The first half 14 and the second half 16 when fastened together may create an electrical box extender 12. When fastened together, the exemplary electrical box extender 12 may resemble what appears to be a square or rectangle. The exemplary electrical box extender 12 may have therefore have four walls that could be referred to as a top wall 51, a right wall 52, a bottom wall 53, and a left wall 54, all with respect to the x-y plane as can be seen in FIG. 4. The four walls 51, 52, 53, 54 may with their lengths and overall shape form an outer perimeter 50 of the electrical box extender 12.

Alternative configurations are contemplated as many shapes of electrical box extenders 12 exist, such as square, rectangular, hexagonal, octagonal, circular, or even a combination of rectangular walls with circular walls, etc. as understood by those of ordinary skill in the art.

The first half 14 includes knockouts 18 and 19, which may be similar in size to the knockouts 24 and 26 from the backer plate 20. These knockouts 18 and 19 may be configured to have alternating diameters, all the same diameter, or all different diameters, or further, the knockouts 18 and 19 may be configured to have three knockouts per wall of electrical box extender. However, a different number of knockouts 18 and/or 19 is contemplated that may be configured to maximize the number of knockouts per wall of the electrical box extender 12 while maintaining industry-size receiving knockouts for electrical conduits 22. Each of the first half 14 and the second half 16 have an outer edge 94 and an inner edge 96.

The first half 14 has a female end 56 having a tab 60 defining an opening 64, and the second half 16 has a male end 58 having a tab 62 defining an opening 66. The opening 64 defined by the tab 60 of the female end 56 is configured to align with the opening 66 defined by the tab 62 of the male end 58 on the second half 16. The first half 14 similar has a male end 58 configured in the same manner as the male end 58 of the second half 16, and the second half 16 similarly has a female end 56 configured in the same manner as the female end 56 of the first half 14.

In between the right wall 52 and the bottom wall 53 on the second half 16, a second corner tab 74 is defined, extending inward from the second half corner 70. A similar arrangement exists on the first half 14 from which the left wall 54 and the top wall 51 come together to form corner 68. In the corner 68 of the first half 14, a first corner tab 72 for the first half 14 is included, protruding inward from the first half corner 68. Within each of the first corner tab 72 and the second corner tab 74, a first opening 76 in the first corner tab and a second opening 78 in the second corner tab are each defined respectively for the first half 14 and the second half 16.

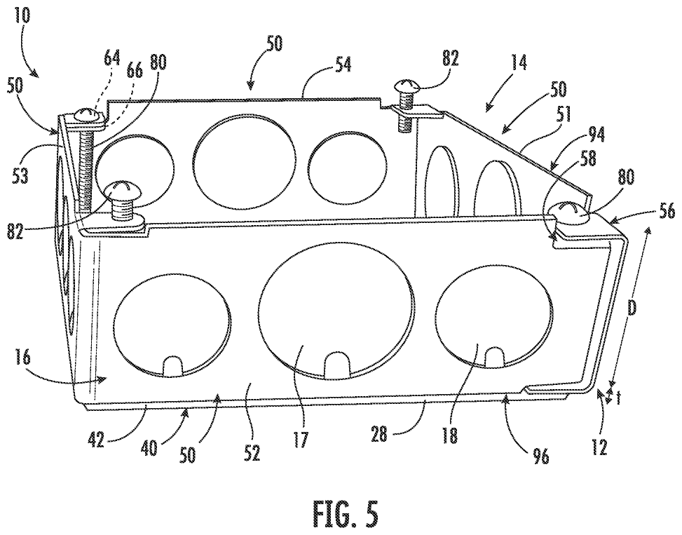

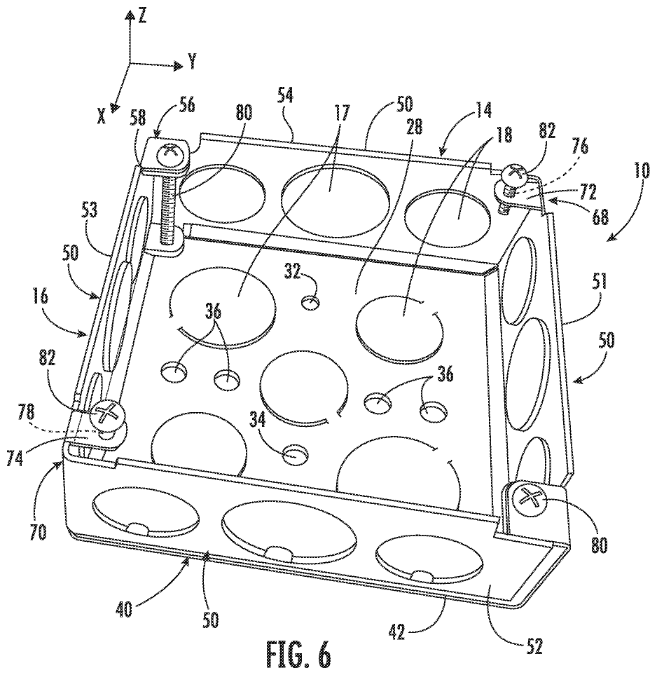

Referring now to FIGS. 5 and 6, as noted above, the electrical box extender 12 is formed by the first half 14 and the second half 16, and further the electrical box 10 can be formed by combining the first half 14 and second half 16, further in combination with the backer plate 20.

As can be seen in the exemplary electrical box 10 depicted, the electrical box further includes threaded fasteners 80 to couple the electrical box extender 12 to the backer plate 28 to form the electrical box 10. More specifically, the exemplary electrical box 10 depicted includes a first threaded fastener 80 extending through the first electrical box extender opening (i.e., a first opening formed by a combination of openings 64, 66) and engaged with the first threaded opening 30 and a second threaded fastener 80 extending through the second electrical box extender opening (i.e., a second opening formed by a combination of openings 64, 66) and engaged with the second threaded opening 31 (see, e.g., FIG. 2), the first and second threaded fasteners 80 coupling the electrical box extender 12 to the backer plate 28 to form the electrical box 10.

The threaded fasteners 80 may be inserted into openings 66 and 64 (when the openings 66 and 64 are overlapping) to fasten the first half 14 and the second half 16 together, and also fasten the electrical box extender 12 to the backer plate 20, for example by aligning openings 64, 66 with opening 30 or opening 31 of the backer plate 20.

As can be seen in FIG. 5, the corner tabs 72 and 74 may include a means for fastening 82 such as a threaded fastener to attach a cover plate 84 (FIG. 1) to the electrical box 10 if so desired. The means for fastening a cover plate 84 to the electrical box extender 12 can be any of the means for fastening that were previously mentioned, although in the exemplary model depicted in FIG. 5, threaded fasteners 82 are what may be inserted into first opening 76 and second opening 78 to attach to a cover plate 84.

Further, it is contemplated that the first opening 76 and second opening 78 may receive a means for fastening to fasten an additional electrical box extender (not shown) on top of the electrical box extender 12 depicted. The system of the additional electrical box extender attached to the electrical box extender 12 would be on the outer edge 94 of the electrical box extender 12.

As shown in FIGS. 5 and 6, the exemplary backer plate 20 provides a snug fit to the back of the electrical box extender 12. When using a first half 14 and a second half 16, which often have non-threaded openings 64 and 66, in this instance it may be important for the backer plate 20 to have the openings 30, 31 be threaded if the means for fastening the electrical box extender 12 to the backer plate 20 is to function via a threaded fastener.

In alternative configurations, it is contemplated that the means for fastening may be other than that of a threaded fastener, and that in this instance the first and second openings 30, 31, need not be threaded, and the threaded fasteners 80 could instead be any of nails, anchors, rivets, glue, tape, Velcro, magnets, pins, threads, etc.

The backer plate 20 provides a way to create an electrical box 10 when, e.g., no leftover electrical boxes 10 can be found, and electrical box extenders 12 and/or first half 14 and second half 16 may be found in excess.

It will be appreciated that in certain exemplary aspects, a method of forming an electrical box assembly may be provided.

The method may include providing a backer plate having a planar wall defining a perimeter, four edges along the perimeter, and four corners between adjacent edges, the planar wall further defining at least a first threaded opening located at a first corner of the four corners and a second threaded opening located at a second corner of the four corners. As used herein, the term “providing” does not require forming or manufacturing a component.

The method may further include providing an electrical box extender separate from the backer plate, the electrical box extender including four wall and defining a first electrical box extender opening and a second electrical box extender opening.

Further, still, the method may include coupling the electrical box extender to the backer plate with a first threaded fastener extending through the first electrical box extender opening and engaged with the first threaded and with a second threaded fastener extending through the second electrical box extender opening and engaged with the second threaded opening.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A backer plate for use with an electrical box extender to form an electrical box, the backer plate comprising:
a planar wall defining a perimeter, four edges along the perimeter, and four corners between adjacent edges, the planar wall further defining at least a first threaded opening located at a first corner of the four corners and a second threaded opening located at a second corner of the four corners, wherein the first and second threaded opening are configured to rotatably engage with a first and second threaded fastener, respectively, to fasten the electrical box extender to the planar wall of the backer plate to form the electrical box.

2. The backer plate of claim 1, wherein the four edges include a first edge, a second edge, a third edge, and a fourth edge, and wherein each of the first edge, the second edge, the third edge and the fourth edge are all equal in length.

3. The backer plate of claim 2, wherein the four edges of the backer plate forms a square shape that measures four inches by four inches.

4. The backer plate of claim 1, wherein the first threaded opening and the second threaded opening each comprise an 8/32nd of an inch in diameter threading.

5. The backer plate of claim 1, wherein the planar wall defines a plurality of knockouts configured to receive one or more of an electrical conduit.

6. The backer plate of claim 5, wherein the planar wall defines a plurality of internal openings placed in between the plurality of knockouts, wherein each of a given internal opening from the plurality of internal openings comprises a smaller area than each of a given knockout area from the plurality of knockouts.

7. An electrical box assembly comprising:
a backer plate comprising a planar wall defining a perimeter, four edges along the perimeter, and four corners between adjacent edges, the planar wall further defining at least a first threaded opening located at a first corner of the four corners and a second threaded opening located at a second corner of the four corners;
an electrical box extender separate from the backer plate, the electrical box extender comprising four wall and defining a first electrical box extender opening and a second electrical box extender opening; and
a first threaded fastener extending through the first electrical box extender opening and engaged with the first threaded opening and a second threaded fastener extending through the second electrical box extender opening and engaged with the second threaded opening, the first and second threaded fasteners coupling the electrical box extender to the backer plate to form an electrical box.

8. The electrical box assembly of claim 7, wherein the four walls of the electrical box extender extend perpendicularly from the backer plate.

9. The electrical box assembly of claim 7, wherein the four walls of the electrical box extender extend perpendicularly from the four edges of the backer plate.

10. The electrical box assembly of claim 7, wherein the electrical box extender comprises a first half and a second half, wherein both the first half and the second half each comprise a male end and a female end, wherein each of the female end and the male end together form one of the first electrical box extender opening or the second electrical box extender opening.

11. The electrical box assembly of claim 7, wherein the planar wall defines a plurality of knockouts configured to receive one or more of an electrical conduit.

12. The electrical box assembly of claim 11, wherein the planar wall defines a plurality of internal openings placed in between the plurality of knockouts, wherein each of a given internal opening from the plurality of internal openings comprises a smaller area than each of a given knockout area from the plurality of knockouts.

13. The electrical box assembly of claim 7, wherein the four edges include a first edge, a second edge, a third edge, and a fourth edge, and wherein each of the first edge, the second edge, the third edge and the fourth edge are all equal in length.

14. The electrical box assembly of claim 13, wherein the four edges of the backer plate forms a square shape that measures four inches by four inches.

15. The electrical box assembly of claim 7, wherein the first threaded opening and the second threaded opening each comprise an 8/32nd of an inch in diameter threading.

16. A method of forming an electrical box assembly, comprising:
providing a backer plate comprising a planar wall defining a perimeter, four edges along the perimeter, and four corners between adjacent edges, the planar wall further defining at least a first threaded opening located at a first corner of the four corners and a second threaded opening located at a second corner of the four corners;
providing an electrical box extender separate from the backer plate, the electrical box extender comprising four wall and defining a first electrical box extender opening and a second electrical box extender opening; and
coupling the electrical box extender to the backer plate with a first threaded fastener extending through the first electrical box extender opening and engaged with the first threaded and with a second threaded fastener extending through the second electrical box extender opening and engaged with the second threaded opening.

17. The method of claim 16, wherein the four walls of the electrical box extender extend perpendicularly from the backer plate.

18. The method of claim 16, wherein the four walls of the electrical box extender extend perpendicularly from the four edges of the backer plate.

19. The method of claim 16, wherein the electrical box extender comprises a first half and a second half, wherein both the first half and the second half each comprise a male end and a female end, wherein each of the female end and the male end together form one of the first electrical box extender opening or the second electrical box extender opening.

20. The method of claim 16, wherein the planar wall defines a plurality of knockouts configured to receive one or more of an electrical conduit.
